(19) United States
(12) Patent Application Publication
(10) Pub. No.: US 2026/0037272 A1
(43) Pub. Date: Feb. 5, 2026

(54) TRIGGER RATE IMPROVEMENT POST PROGRAM SUSPEND

(71) Applicant: Micron Technology, Inc., Boise, ID (US)

(72) Inventors: Ugo Russo, Boise, ID (US); Shyam Sunder Raghunathan, Woodlands (SG); Nicola Ciocchini, Boise, ID (US)

(21) Appl. No.: 19/269,772

(22) Filed: Jul. 15, 2025

Related U.S. Application Data
(60) Provisional application No. 63/677,898, filed on Jul. 31, 2024.

(51) Int. Cl. G06F 9/4401

(52) U.S. Cl. CPC G06F 9/4418

(57) ABSTRACT

One method includes suspending a program operation being performed on a group of memory cells. Prior to resuming the program operation, a program status corresponding to the program operation can be determined. The method includes, responsive to determining a first program status and prior to resuming the program operation: overwriting first program data stored in a first data cache of a page buffer with second program data stored in a second data cache of the page buffer; and resuming the program operation in the absence of the first program data. The method includes, responsive to determining a second program status and prior to resuming the program operation: preventing the first program data stored in the first data cache from being overwritten with the second program data stored in the second data cache; and resuming the program operation utilizing the first program data in the absence of the second program data.

### PRIORITY INFORMATION

This application claims the benefit of U.S. Provisional Application No. 63/677,898, filed Jul. 31, 2024, the contents of which are incorporated herein by reference.

### TECHNICAL FIELD

Embodiments of the disclosure relate generally to memory systems, and more specifically, relate to apparatuses and methods for trigger rate improvement post program suspend in memory systems.

### BACKGROUND

A memory system can be a storage device, a memory module, or a hybrid of a storage device and a memory module. Examples of a storage device include a solid-state drive (SSD), a Universal Flash Storage (UFS) drive, a secure digital (SD) card, an embedded Multiple Media Card (eMMC), and a hard disk drive (HDD). Examples of memory modules include a dual in-line memory module (DIMM) and various types of non-volatile dual in-line memory modules (NVDIMMs). Memory systems include one or more memory components (e.g., memory devices) that store data. The memory components can be, for example, non-volatile memory components (e.g., NAND flash memory devices) and volatile memory components (e.g., DRAM devices). In general, a host system can utilize a memory system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing system having a memory system for performing error handling avoidance in accordance with various embodiments of the present disclosure.

FIG. 2 is a schematic diagram illustrating an example memory array that can be operated in accordance with various embodiments of the present disclosure.

FIG. 3 illustrates example threshold voltage distributions associated with memory cells programmed in accordance with various embodiments of the present disclosure.

FIG. 4 illustrates an example of a threshold voltage distribution shift that can be reduced or prevented in association with trigger rate improvement post program suspend in accordance with various embodiments of the present disclosure.

FIG. 5 illustrates program data corresponding to multiple data caches of a page buffer in association with trigger rate improvement post program suspend in accordance with various embodiments of the present disclosure.

FIG. 6 is a flow diagram that illustrates an example method for trigger rate improvement post program suspend in accordance with various embodiments of the present disclosure.

FIG. 7 illustrates an example computing system for performing trigger rate improvement post program suspend in accordance with various embodiments of the present disclosure.

### DETAILED DESCRIPTION

Aspects of the present disclosure are directed to apparatuses and methods for trigger rate improvement post program suspend within memory systems, such as storage systems comprising NAND flash memory devices. Various memory systems may prioritize read operations over program and erase operations in order to meet quality of service (QoS) metrics, for example. For instance, program operations can be suspended (e.g., paused) in order to service a read operation and then later resumed. As an example, depending on the usage case, a program operation may be suspended and resumed multiple times prior to completion.

Since the voltage levels (e.g., threshold voltages (Vts)) of cells being programmed can shift over time (e.g., due to charge loss), various programming and reading algorithms can be adjusted to account for effects of suspending and resuming program operations. For example, the magnitude and/or step size associated with programming signals (e.g., pulses) can be adjusted and/or additional program verify operations can be utilized upon resuming a suspended program operation. However, in various instances, program data used to properly place the Vt of a memory cell post suspend may be unavailable. As an example, as described further below, various programming algorithms utilize a selective slow programming convergence (SSPC) technique to more accurately set the Vt level of a cell. However, such SSPC data, which is stored in a data latch of a page buffer, can be overwritten (e.g., with other program data) in association with resuming a suspended program operation.

Additionally, program suspend resumes can lead to a shift (e.g., downward) the Vt distributions by causing an edge of the Vt distribution to be placed at a lower Vt level than it would otherwise be placed. Such Vt shift can be due to, for example, a combination of the loss of SSPC data and smaller steps to the program voltage (e.g., “gate-steps”) post suspend resume. Such shifts to the Vt placement can be more pronounced for higher Vt distributions. For example, for a cell programmable to eight states (e.g., L0-L7), the Vt distribution corresponding to L7 can experience the greatest amount of Vt shift due to program suspend resumes. The Vt shifts resulting from program suspend resumes can be compounded as the quantity of suspend resumes increases for particular group of cells undergoing the program operation.

Various techniques can be used to compensate for Vt shifts and/or widening of Vt distributions in order to achieve a desired bit error rate (BER) in association with reading programmed cells. However, prior compensation approaches may not adequately account for the effects of program suspend resume operations. Accordingly, prior approaches can lead to higher BERs, which can lead to an increased rate of the memory system entering a “read error handling” procedure as a result of failing to decode data responsive to a particular read command (e.g., a host read command). Such read error handling procedures are often more time consuming and/or resource intensive, which adversely affects system QoS. The rate at which a memory system enters a read error handling procedure can be referred to as the “trigger rate” and is often used as a critical metric for memory systems. Error recovery operations associated with read error handling can include various read re-try procedures and/or redundant array of independent NAND (RAIN) recovery, for example.

Various memory systems employ error detection/correction schemes such as error correction code (ECC) schemes that involve encoding data programmed to a group of cells (e.g., a page) and which are capable of correcting up to a threshold number of errors in a page of data being read responsive to a host read command. Such memory systems can avoid entering read error handling unless/until the system (e.g., the ECC engine) is unable to decode the data (e.g., the number of erroneous bits in the read data exceeds the threshold number correctable based on the strength of the ECC), which can be referred to as an uncorrectable ECC error (UECC).

Various embodiments of the present disclosure address the above and other deficiencies by providing apparatuses and methods that can provide an improved trigger rate post program suspend in memory systems. As described further herein, various embodiments include a memory device comprising an array of memory cells coupled to a page buffer having multiple caches. A controller is coupled to the memory device and configured to cause a program operation being performed on a group of memory cells (e.g., a page of cells) of the array to be suspended prior to completion. The memory device is configured to, prior to resuming the program operation, determine a program status corresponding to the program operation. In a number of embodiments, the program status refers to whether programming of the lower page of multiple pages has completed. Responsive to determining a first program status (e.g., that the lower page programming is incomplete), and prior to resuming the program operation: first program data (e.g., SSPC data) stored in a first data cache of the page buffer is overwritten with second program data (e.g., lower page data) stored in a second data cache of the page buffer; and the program operation resumes in the absence of the first program data. Responsive to determining a second program status (e.g., that the lower page programming has completed), and prior to resuming the program operation: the first program data stored in the first data cache is prevented from being overwritten with the second program data stored in the second data cache; and the program operation is resumed utilizing the first program data in the absence of the second program data. In this manner, various embodiments can provide a “safe” program suspend resume feature for a memory system such as a memory system comprising NAND memory devices, for example.

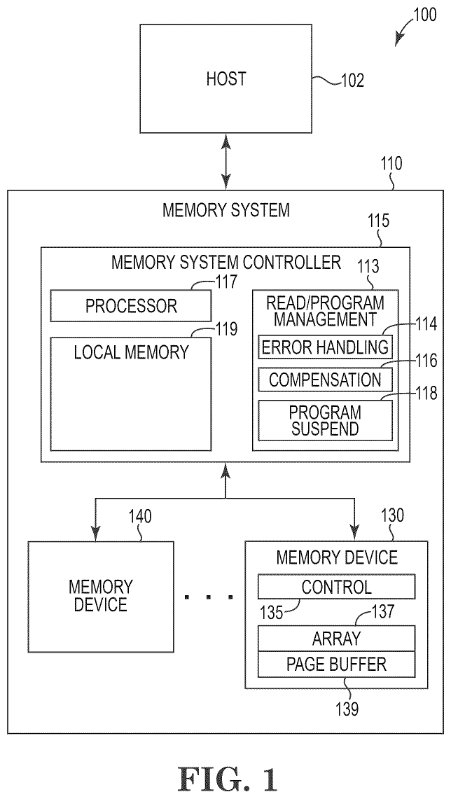

FIG. 1 illustrates an example computing system 100 having a memory system 110 for trigger rate improvement post program suspend within memory systems in accordance with various embodiments of the present disclosure. The memory system 110 includes a system controller 115 and media in the form of a number of memory devices, which can be one or more non-volatile memory devices (e.g., 130), one or more volatile memory devices (e.g., 140), or a combination of such.

The memory system 110 can be a storage system, a memory module, or a hybrid of a storage system and a memory module, for example. Example storage systems can include, but are not limited to, a solid-state drive (SSD), or a managed NAND (MNAND) drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM). In general, the computing environment shown in FIG. 1 can include a host system 102 (e.g., a host system) that is coupled to one or more memory system 110, which can be of a same or different type. As used herein, “coupled to” generally refers to a connection between components, which can be an indirect communicative connection or direct communicative connection (e.g., without intervening components), whether wired or wireless, including connections such as electrical, optical, magnetic, etc. The host 102 can use the memory system 110 by writing data to and reading data from the memory system 110.

The host 102 can be a computing device such as a desktop computer, laptop computer, network server, mobile device, vehicle (e.g., airplane, drone, vehicle, or other conveyance), Internet of Things (IoT) enabled device, or other such computing device that includes a memory and a processing device (e.g., a processor). The host 102 can, for example, include a processor chipset and a software stack executable thereby. The host 102 can be coupled to the memory system 110 via a physical host interface (not shown in FIG. 1) that can provide an interface for passing control, address, data, and other signals between the memory system 110 and the host 102. Examples of a physical host interface include, but are not limited to, a serial advanced technology attachment (SATA) interface, a peripheral component interconnect express (PCIe) interface, a universal flash storage (UFS) interface, a universal serial bus (USB) interface, Fibre Channel, Serial Attached SCSI (SAS), etc. The physical host interface can be used to transmit data between the host 102 and the memory system 110. The host 102 can further utilize an NVM Express (NVMe) interface, for example, to access the memory devices 130 when the memory system 110 is coupled with the host 102 by the PCIe interface.

The memory devices can include various combinations of the different types of non-volatile memory devices 130 and/or volatile memory devices 140. The volatile memory devices (e.g., memory device 140) can be, but are not limited to, random access memory (RAM), such as dynamic random access memory (DRAM) and synchronous dynamic random access memory (SDRAM). In some embodiments, the memory devices 130, 140 include local media controllers (e.g., local controller 135) that operate in conjunction with memory system controller 115 to execute operations on one or more memory cells of the memory devices 130, 140.

An example of non-volatile memory devices (e.g., memory device 130) includes a NAND flash memory device. Each of the memory devices 130 can include one or more arrays 137 of memory cells. The memory cells can include single level cells (SLCs) that can store one bit per cell, multi-level cells (MLCs) that can store two bits per cell, triple level cells (TLCs) that can store three bits per cell, quad-level cells (QLCs) that can store four bits per cell, and/or penta-level cells (PLCs) that can store five bits per cell, among others. NAND arrays can have a two-dimensional (2D) or three-dimensional (3D) architecture. As described further below, a NAND flash memory includes an array of many memory cells that can be arranged in row and column fashion and grouped in physical blocks. The cells can include a charge storage node such as a floating gate or charge-trap layer which allows the cells to be programmed to store one or more bits by adjusting the charge stored on the storage node. For example, such cells can be programmed to multiple different threshold voltage (Vt) levels, which provides Vt distributions corresponding to different respective data states (e.g., logical values). Accordingly, a cell programmable to 2ⁿ different Vt levels can store “n” bits. For example, a cell programmable to eight different states (e.g., n=3) can store three bits data, with each state being encoded with a different three-bit pattern (e.g., 000, 010, 111, etc.). A sensing operation (e.g., a read or a program verify operation) involves determining the current data state of the cell by comparing the current Vt of the cell to one or more reference voltages (e.g., read voltages) to identify the current Vt distribution to which the cell belongs.

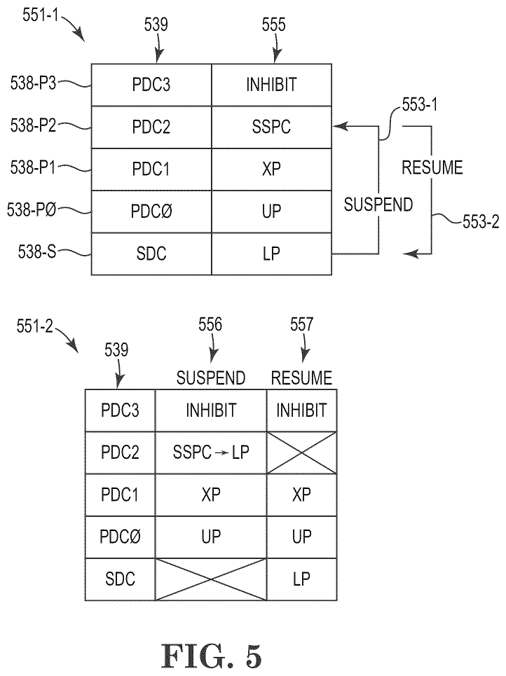

As shown in FIG. 1, a page buffer 139 can be coupled to the array 137. As described further below in association with FIG. 5, for example, the page buffer 139 can include multiple data latches, which may be referred to as a number of primary data caches (PDCs) and a secondary data cache (SDC). The data caches can store data associated with programming memory cells, and which may be referred to as program data. The program data can be, for example, data (e.g., bit values) corresponding to one or more pages (e.g., logical pages) of data to be programmed to a group of cells (e.g., a physical page), data associated with a program verify operation (e.g., an inhibit bit) and/or data associated with a pre-program verify voltage (e.g., an SSPC bit). The page buffer 139 can comprise multiple buffers allocated on a per bit line basis and can be operated by controller 135 in association with handling program suspend resume operations in accordance with embodiments described herein. The controller 135 can comprise hardware (e.g., circuitry), firmware, software, or a combination thereof.

Although non-volatile memory components such as NAND type flash memory are described, the memory device 130 can be based on various other types of non-volatile memory such as read-only memory (ROM), phase change memory (PCM), magnetoresistive random access memory (MRAM), NOR flash memory, electrically erasable programmable read-only memory (EEPROM), etc.

The memory system controller 115 can communicate with the memory devices 130 and 140 to perform operations such as reading data, writing data, or erasing data at the memory devices 130 and other such operations. The memory sub-system controller 115 can include hardware such as one or more integrated circuits and/or discrete components, a buffer memory, or a combination thereof. The memory system controller 115 can be a microcontroller, special purpose logic circuitry (e.g., a field programmable gate array (FPGA), an application specific integrated circuit (ASIC), etc.), or other suitable processing circuitry.

The controller 115 can include a processing device that can be one or more processors (e.g., processor 117) configured to execute instructions that can be stored in local memory 119. The local memory 119 can store instructions for various processes, operations, logic flows, and routines that control operation of the memory system 110, including handling communications between system 110 and host 102.

In general, the controller 115 can receive commands or operations from the host 102 and can convert the commands or operations into instructions or appropriate commands to achieve the desired access to the memory devices 130 and 140. The controller 115 can be responsible for other operations such as wear leveling operations, garbage collection operations, error detection and error-correcting code (ECC) operations, encryption operations, caching operations, and address translations between a logical block address and a physical block address that are associated with the memory devices 130, 140.

As illustrated in FIG. 1, the controller 115 includes a read/program management component 113 that can be used to implement trigger rate improvement post program suspend strategies in accordance with embodiments of the present disclosure. Although illustrated as being within the controller 115, at least a portion of the component 113 can be located external to controller 115. The read/program management component 113 can comprise hardware (e.g., circuitry), firmware, software, or a combination thereof. The read/program management component 113 includes an error handling component 114 that can implement various data recovery operations in response to host read operations that fail to be successfully decoded (e.g., via an ECC and/or LDPC engine), for example. The read/program management component 113 includes a compensation component 116 that can be responsible, for example, for determining and/or providing adjusted read offset voltages used to read memory cells in association with compensating for Vt shifts due to various effects including, but not limited to, SCL, disturb effects, interference effects, etc.

The read/program management component 113 also includes a program suspend component 118. The program suspend component 118 can issue suspend and resume commands to the memory devices 130. For example, in embodiments in which the controller 115 communicates with the memory devices 130 over an Open NAND Flash Interface (ONFI), the suspend command may be a command given by 84h and the suspend command may be given by 13h.

While the example memory system 110 in FIG. 1 has been illustrated as including the controller 115, in another embodiment of the present disclosure, a memory system 110 may not include a controller 115, and can instead rely upon external control (e.g., provided by a processor or controller separate from the memory system 110, such as by host 102 communicating directly with the memory devices 130, 140). Although the memory system 110 is shown as physically separate from the host 102, in a number of embodiments the memory system 110 can be embedded within the host 102. Alternatively, the memory system 110 can be removable from the host 102.

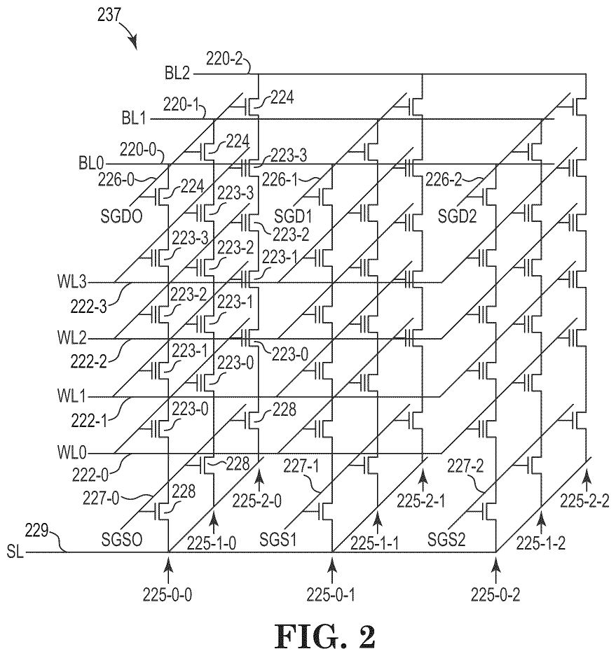

FIG. 2 is a schematic diagram illustrating an example memory array 237 that can be operated in accordance with various embodiments of the present disclosure. The memory array 237 can be located in a memory device such as memory device 130 described in FIG. 1, for example. In this example, the memory array 237 is a 3D NAND array (e.g., RG NAND array or a floating gate NAND array).

The memory array 237 comprises a number of access lines (word lines) 222-0 (WL0), 222-1 (WL1), 222-2 (WL2), and 222-3 (WL3) and a number of sense lines (bit lines) 220-0 (BL0), 220-1 (BL1), and 220-2 (BL2) coupled to multiple strings 225-0-0, 225-0-1, 225-0-2, 225-1-0, 225-1-1, 225-1-2, 225-2-0, 225-2-1, and 225-2-2. The word lines, bit lines, and strings are collectively referred to as word lines 222, bit lines 220, and strings 225, respectively. Although four word lines 222, three bit lines 220, and nine strings 225 are shown, embodiments are not so limited.

Each of the strings 225 comprises a number of memory cells (referred to collectively as memory cells 223) located between a select transistor 224 and a select transistor 228. For example, as shown in FIG. 2, strings 225-0-0, 225-1-0, and 225-1-2 each respectively comprise memory cells 223-0, 223-2, 223-2, and 223-3 located between select transistors 224 and 228 (e.g., respective drain-side select gate (SGD) 224 and source-side select gate (SGS) 228). The memory cells 223 can be floating gate transistors or charge trap cells with the cells 223 of a given string 225 sharing a common channel region (e.g., pillar). As shown, the memory cells 223 of a given string are series-coupled source to drain between the SGD transistor 224 and the SGS.

The memory cells 223 of the strings 225 are stacked vertically such that they are located on distinct tiers/levels of the memory array 237. Each word line 222 can be commonly coupled to all the memory cells at a particular tier/level. For example, word line 222-0 can be coupled to (e.g., as the control gate) the nine memory cells 223-0 corresponding to the nine respective strings 225.

The select gate transistors 224 and 228 can be controlled (e.g., turned on/off) via the corresponding select gate signals SGD0, SGD1, SGD2, SGS0, SGS1, and SGS2 in order to couple the strings 225 to their respective bit lines 220 and a common source line (SL) 229 during memory operations (e.g., reads, writes, erases). As shown in FIG. 2, the select gate signals SGD0, SGD1, and SGD2 are provided (e.g., to the gates of transistors 224) via respective conductive lines 226-0, 226-1, and 226-2, and the select gate signals SGS0, SGS1, and SGS2 are provided (e.g., to the gates of transistors 228) via respective conductive lines 227-0, 227-1, and 227-2. Although the signals SGS0, SGS1, and SGS2 are shown on separate conductive lines 227, in some embodiments the conductive lines 227-0, 227-1, and 227-2 may be coupled via a common SGS line.

To perform memory operations (e.g., read, program, erase, etc.) on the array 237, particular voltages (e.g., bias voltages) can be applied to the word lines 222, bit lines 220, and source line 229. The particular voltages applied depends on the memory operation being performed, and different voltages may be applied to the word lines 222 during a particular memory operation in order to store data in a cell (or page of cells) or read data from a cell.

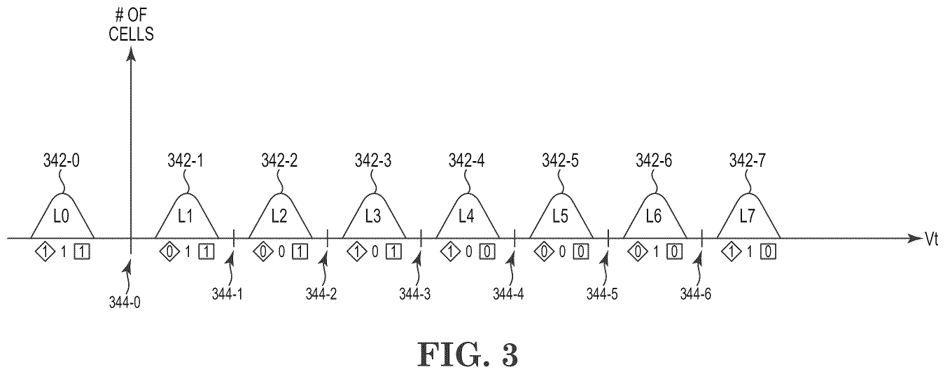

FIG. 3 illustrates example threshold voltage distributions associated with memory cells programmed in accordance with various embodiments of the present disclosure. In this example, the memory cells are TLCs each being programmable to one of eight data states (e.g., L0 to L7) 342-0 (L0), 342-1 (L1), 342-2 (L2), 342-3 (L3), 342-4 (LA), 342-5 (L5), 342-6 (L6), and 342-7 (L7), with the states being encoded with different respective 3-bit bit patterns (e.g., 111, 011, 001, 101, 100, 000, 010, and 110). Each of the bits in the 3-bit stored bit patterns correspond to a different logical page (of data). For instance, the least significant bit (LSB) (right most bit shown as boxed in FIG. 3) can correspond to a first page, the middle bit can correspond to a second page, and the most significant bit (MSB) (left most bit as indicated by a diamond symbol in FIG. 3) can correspond to a third page. The first, second, and third pages can be referred to herein as the lower page (LP), upper page (UP), and extra page (XP), respectively.

Embodiments are not limited to TLC memory cells (e.g., cells storing three bits of data). For instance, a number of embodiments can include memory cells configured to store more or fewer than three bits of data and/or a fractional number of bits of data per cell, and embodiments are not limited to the particular encoding assigned to the data states L0 through L7.

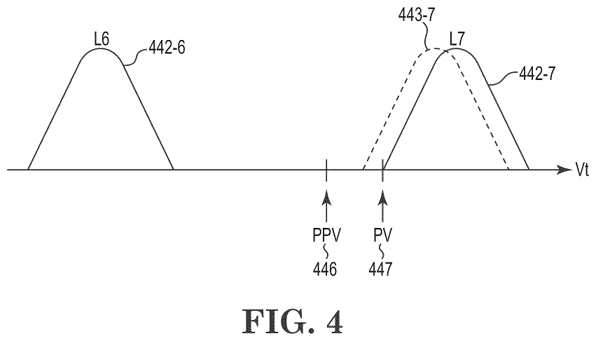

In operation, programming the memory cells involves providing a programming signal, which can be a plurality of pulses, to a selected word line (e.g., the word line coupled to the cells being programmed) serving as the gate of the cells in order to gradually increase the Vt of the cell from a Vt level corresponding to an erase state (e.g., L0) to a Vt level corresponding to one of states L0 through L7. As described below in association with FIG. 4, one or more program verify and/or pre-program verify operations can be used in association with programming the cells to the target state. The three logical pages to be programmed to a group of cells can be programmed in accordance with a one-pass or two-pass algorithm, for example.

The diagram illustrated in FIG. 3 illustrates a number of read voltages 344-0, 344-1, 344-2, 344-3, 344-4, 344-5, and 344-6 (referred to generally as read voltages 344) associated with reading the bits of the three respective stored pages. A number of read strobes (e.g., using a number of the read voltages 344 applied to the selected word line) may be required in association with a reading a particular page of data. For instance, in this example, the encoding is such that a single read strobe (e.g., at read voltage 344-3) can be used to determine whether the lower page of the cell is a “0” or a “1.” Also, in this example, two read strobes can be performed to decode the middle page (e.g., one strobe at read voltage 344-1 and one strobe at read voltage 344-5). Also, in this example, the encoding is such that four read strobes must be performed in order to decode the upper page (e.g., strobes at read voltages 344-0, 344-2, 344-4, and 344-6).

The read voltages 344 are generally placed in the middle between adjacent states 342 in order to provide a lowest BER when reading the cells. Therefore, it can be beneficial to compensate for shifts of the states 342 by adjusting the read voltages 344 in order to avoid increased BERs and a corresponding increased trigger rate.

FIG. 4 illustrates an example of a threshold voltage distribution shift that can be reduced or prevented in association with trigger rate improvement post program suspend in accordance with various embodiments of the present disclosure. The Vt distributions 442-6 and 442-7 can be analogous to respective Vt distributions 342-6 and 342-7 of FIG. 3. Accordingly, distribution 442-6 corresponds to a level (e.g., programmed data state) L6 of a TLC and distribution 442-7 corresponds to level 7 of a TLC. However, embodiments are not limited to TLC memory cells.

The Vt distribution 443-7 represents a shift (e.g., downward) in the placement of the distribution corresponding to L7 (442-7) which can occur due to one or more suspensions of a program operation during programming of a group of cells. As an example, and as described further below in association with FIG. 5, such downward shift can be a result of SSPC data being overwritten within the page buffer in association with resuming the program operation after the suspension. The amount of downward shift of L7 can be greater in instances in which multiple program suspend-resumes occur toward the end of the programming time (tPROG) (e.g., when L6/L7 are being programmed).

The downward shift of L7 (442-7) can have adverse effects such as increasing the BER associated with reading the memory cells. For example, some read compensation schemes may utilize the amount of Vt shift to L7 to determine an amount slow charge loss (SCL) time and can select a set of read offset voltages (e.g., read voltages 344 of FIG. 3) based thereon. In such schemes, the lower Vt distribution 443-7 can induce an incorrect compensation by causing selection of read offset voltages that result in a higher BER than would have otherwise been selected for the non-shifted Vt distribution 442-7.

In operation, programming of cells can involve applying programming pulses to word line (e.g., cell gate) until the cell's Vt reaches a program verify (PV) voltage, at which point the cell can be “inhibited” from further programming. For example, an inhibit voltage can be applied to the bit lines corresponding to cells being programmed to L7 once their Vt is determined to have reached PV 447 (e.g., via a program verify operation).

As a cell's Vt reaches the PV level (e.g., 447), it can be beneficial to reduce the magnitude of subsequent programming pulses to be applied in order to avoid “overshooting” the target Vt level, which leads to a wider Vt distribution. Accordingly, if a cell's Vt has reached a program pre-verify (PPV) level (e.g., 446), but has not yet reached the PV level (e.g., 447), a process such as selective slow programming convergence (SSPC) can be employed in order to improve (e.g., reduce) the Vt distribution width. For instance, SSPC can involve, once a cell passes the PPV level 446, a small voltage (referred to as an SSPC voltage) may be applied to the corresponding bit line, which causes the programming of the cell to slow down during one or more subsequent programming pulses.

As noted above and described further below, a page buffer coupled to a bit line can include a data cache that stores SSPC data (e.g., an SSPC bit) that indicates whether the SSPC voltage should be applied to the bit line during a subsequent programming pulse. Accordingly, overwriting of the SSPC data in the page buffer can adversely affect the Vt distribution (e.g., 442-7) by preventing performance of SSPC on cells that have passed PPV 446 but not PV 447.

FIG. 5 illustrates program data corresponding to multiple data caches of a page buffer in association with trigger rate improvement post program suspend in accordance with various embodiments of the present disclosure. In this example, the page buffer 539 includes five data caches 538-S (SDC), 538-P0 (PDC0), 538-P1 (PDC1), 538-P2 (PDC2), and 538-P3 (PDC3), which can be referred to collectively as data caches 538. The data caches 538-0, 538-P1, 538-P2, and 538-P3 can be referred to as primary data caches, and data cache 538-s can be referred to as a secondary data cache. The page buffer 539 can be coupled to a particular bit line of an array of memory cells and can be part of a group of page buffers (e.g., page buffer 139 shown in FIG. 1).

Column 555 of table 551-1 indicates respective program data corresponding to the data caches 538 in association with a program operation on TLC memory cells that employs SSPC. In this example, the secondary data cache 538-S stores lower page data (“LP”), the primary data cache 538-P0 stores upper page data (“UP”), and the primary data cache 538-P1 stores extra page data (“XP”). The primary data cache 538-P2 stores the SSPC data (“SSPC”), which indicates whether a corresponding cell has reached the program pre-verify level (e.g., PPV 446 of FIG. 4) such that an SSPC voltage should be applied to the bit line for one or more subsequent programming pulses, and the primary data cache 538-P3 stores inhibit data (“INHIBIT”), which indicates whether the corresponding cell has reached the target program verify level (e.g., PV 447 of FIG. 4).

In various prior approaches, during a program suspend (e.g., in response to receiving a program suspend command represented by arrow 553-1), the lower page data LP stored in the secondary data cache 538-S is copied to the primary data cache 538-P2 to free up data cache 538-S. Column 556 of table 551-2 illustrates the SSPC data being overwritten (e.g., replaced) with the LP data and the data cache 538-S being released. This overwriting of the SSPC data with the LP data ensures that the LP data is not lost and therefore unavailable when the program operation resumes (e.g., in response to receiving a program resume command represented by arrow 553-2). The lower page data LP can then be copied back from primary data cache 538-P2 to the secondary data cache 538-S in association with resuming the program operation post suspend. Column 557 of table 551-2 illustrates the LP data having been copied back to the SDC 538-S upon resume. However, as shown in column 557, the overwriting of the SSPC data in data cache 538-P2 results in the SSPC data being lost and therefore unavailable upon program resume.

Various embodiments of the present disclosure can provide a “safe” program suspend-resume by preventing the loss of program data such as SSPC data in association with executing one or multiple suspend-resume operations. For example, embodiments can involve, upon suspension of a program operation, determining whether the lower page has already been programmed, and if so, preventing the lower page data stored in a particular data cache (e.g., 538-S) from overwriting the SSPC data stored in a different particular data cache (e.g., 538-P2). That is, the LP data can be released from the page buffer instead of the SSPC data being released. Although the LP data may be lost and therefore unavailable when the program operation resumes, because the lower page programming has already completed, the LP data is not needed upon program resume.

In the event that it is determined, upon program suspend, that the lower page has not completed programming, the memory system can proceed with overwriting the SSPC data with the LP data. Although the SSPC data is still lost in this scenario, it will prevent the adverse effects to the higher Vt states (e.g., L6/L7), which are most prone to the lower Vt placement associated with program suspend-resume. Reducing the adverse effects of program suspend-resume, especially on higher Vt states/levels, improves the BER associated with reading memory cells and thereby can improve (i.e., reduce) the trigger rate.

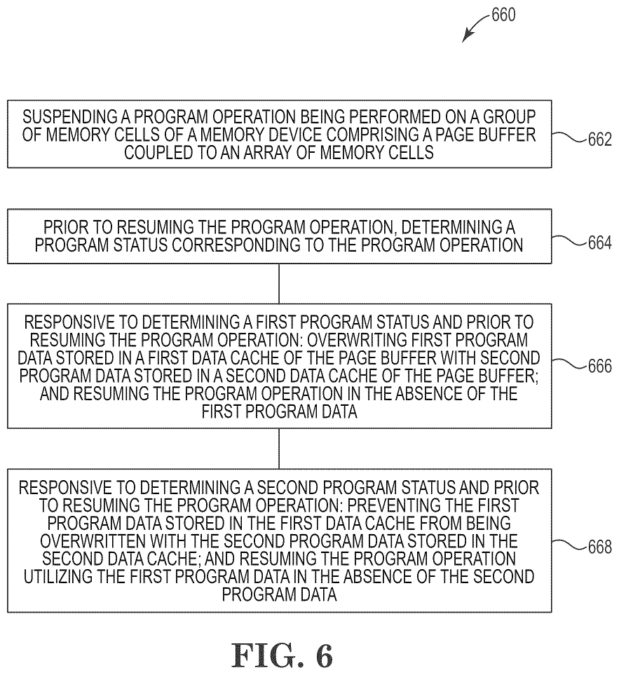

FIG. 6 is a flow diagram 660 that illustrates an example method for trigger rate improvement post program suspend in accordance with various embodiments of the present disclosure. The method 660 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 660 is performed by the controller 115 and/or 135 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At step 662, the method includes suspending a program operation being performed on a group of memory cells of a memory device (e.g., 130) comprising a page buffer (e.g., 139/539) coupled to an array (e.g., 137) of memory cells. At step 664, the method includes, prior to resuming the program operation, determining a program status corresponding to the program operation. The program status can be, for example, whether a lower page has been programmed to the group of cells.

At step 666, the method includes, responsive to determining a first program status (e.g., that programming of the lower page has not yet completed) and prior to resuming the program operation: overwriting first program data (e.g., SSPC data) stored in a first data cache of the page buffer with second program data (e.g., LP data) stored in a second data cache of the page buffer; and resuming the program operation in the absence of the first program data. At step 668, the method includes, responsive to determining a second program status (e.g., that the lower page programming has completed) and prior to resuming the program operation: preventing the first program data (e.g., SSPC data) stored in the first data cache from being overwritten with the second program data (e.g., LP data) stored in the second data cache; and resuming the program operation utilizing the first program data in the absence of the second program data.

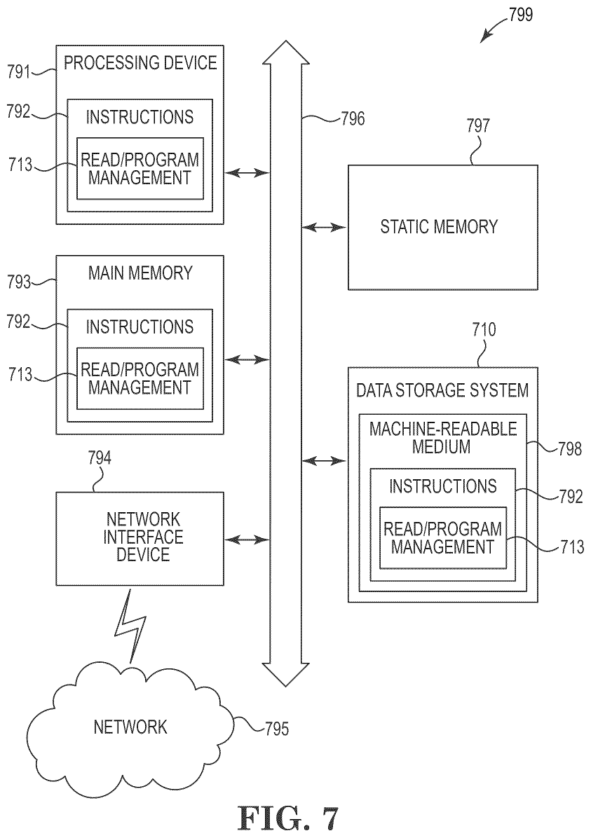

FIG. 7 illustrates an example machine of a computer system 799 within which a set of instructions, for causing the machine to perform one or more of the methodologies discussed herein, can be executed. In some embodiments, the system 799 can correspond to a host system (e.g., the host system 102 of FIG. 1) that includes, is coupled to, or utilizes a memory system (e.g., the memory system 110 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example system 799 includes a processing device 791, a main memory 793 (e.g., read-only memory (ROM), flash memory, dynamic random access memory (DRAM) such as synchronous DRAM (SDRAM) or Rambus DRAM (RDRAM), etc.), a static memory 797 (e.g., flash memory, static random access memory (SRAM), etc.), and a data storage system 710, which communicate with each other via a bus 796.

The processing device 791 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 791 can also be one or more special-purpose processing devices such as an application specific integrated circuit (ASIC), a field programmable gate array (FPGA), a digital signal processor (DSP), network processor, or the like. The processing device 791 is configured to execute instructions 792 for performing the operations and steps discussed herein. The computer system 799 can further include a network interface device 794 to communicate over the network 795.

The data storage system 710 can include a machine-readable storage medium 798 (also known as a computer-readable medium) on which is stored one or more sets of instructions 792 or software embodying one or more of the methodologies or functions described herein. The instructions 792 can also reside, completely or at least partially, within the main memory 793 and/or within the processing device 791 during execution thereof by the computer system 799, the main memory 793 and the processing device 791 also constituting machine-readable storage media. The data storage system 710 can correspond to the memory system 110 of FIG. 1.

In a number of embodiments, the instructions 792 include instructions 713 to implement trigger rate improvement post program suspend functionality corresponding to a read/program management component (e.g., the component 113 of FIG. 1) and/or control component 135 of FIG. 1. While the machine-readable storage medium 798 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The figures herein follow a numbering convention in which the first digit or digits correspond to the drawing figure number and the remaining digits identify an element or component in the drawing. Similar elements or components between different figures may be identified by the use of similar digits. For example, 116 may reference element “16” in FIG. 1, and a similar element may be referenced as 416 in FIG. 4A. As will be appreciated, elements shown in the various embodiments herein can be added, exchanged, and/or eliminated so as to provide a number of additional embodiments of the present disclosure.

For the purposes of the present disclosure, the phrase “A and/or B” means (A), (B), (A) or (B), or (A and B). For the purposes of the present disclosure, the phrase “A, B, and/or C” means (A), (B), (C), (A and B), (A and C), (B and C), or (A, B and C). Additionally, the phrase “at least one of A and B” means one or more of (A) or one or more of (B), or one or more of (A) and one or more of (B) such that both one or more of (A) and one or more of (B) is not required.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
suspending a program operation being performed on a group of memory cells of a memory device comprising a page buffer coupled to an array of memory cells;
prior to resuming the program operation, determining a program status corresponding to the program operation;
responsive to determining a first program status and prior to resuming the program operation:
overwriting first program data stored in a first data cache of the page buffer with second program data stored in a second data cache of the page buffer; and
resuming the program operation in the absence of the first program data; and
responsive to determining a second program status and prior to resuming the program operation:
preventing the first program data stored in the first data cache from being overwritten with the second program data stored in the second data cache; and
resuming the program operation utilizing the first program data in the absence of the second program data.

2. The method of claim 1, wherein the program status corresponds to a completion amount of the program operation at a time the program operation is suspended.

3. The method of claim 2, wherein the completion amount is an indication of whether programming of a particular page of multiple pages being programmed to the group of cells has completed.

4. The method of claim 3, wherein the first program status corresponds to programming of the particular page having not completed, and wherein the second program status corresponds to programming of the particular page having completed.

5. The method of claim 4, wherein the particular page is a lowermost page of the multiple pages being programmed to the group of memory cells.

6. The method of claim 1, wherein determining the program status includes determining a quantity of times the program operation has been suspended since being initiated.

7. The method of claim 6, wherein the first program data is selective slow programming convergence (SSPC) data.

8. The method of claim 7, wherein the second program data is lower page data, and wherein the program operation involves programming at least three pages of data to the group of memory cells.

9. An apparatus, comprising:
a memory device comprising an array of memory cells coupled to a page buffer having multiple caches; and
a controller coupled to the memory device and configured to cause a program operation being performed on a group of memory cells of the array to be suspended prior to completion;
wherein the memory device is configured to, prior to resuming the program operation:
determine a program status corresponding to the program operation;
responsive to determining a first program status and prior to resuming the program operation:
overwrite first program data stored in a first data cache of the page buffer with second program data stored in a second data cache of the page buffer; and
resume the program operation in the absence of the first program data; and
responsive to determining a second program status and prior to resuming the program operation:
prevent the first program data stored in the first data cache from being overwritten with the second program data stored in the second data cache; and
resume the program operation utilizing the first program data in the absence of the second program data.

10. The apparatus of claim 9, wherein the program operation includes programming multiple pages of data to the group of memory cells.

11. The apparatus of claim 10, wherein the first program status is a program status in which programming of a first page of the multiple pages has completed, and wherein the second program status is a program status in which programming of the first page of the multiple pages is incomplete.

12. The apparatus of claim 11, wherein the first page is a lower page of at least three pages, wherein the first program data comprises selective slow programming convergence (SSPC) data, and wherein the second program data comprises lower page data.

13. The apparatus of claim 9, wherein preventing the first program data stored in the first data cache from being overwritten with the second program data stored in the second data cache, and resuming the program operation utilizing the first program data in the absence of the second program data provides a decreased bit error rate (BER) in association with reading the group of cells subsequent to completion of the program operation.

14. The apparatus of claim 9, wherein the page buffer comprises the first data cache, the second data cache, and at least three additional data caches.

15. The apparatus of claim 9, wherein an interface coupling the controller to the memory device is an Open NAND Flash Interface (ONFI).

16. The apparatus of claim 9, further comprising a host coupled to a memory system comprising the controller and the memory device.

17. The apparatus of claim 9, wherein the array comprises a three-dimensional (3D) NAND array of memory cells.

18. An apparatus, comprising:
an array of memory cells;
a page buffer coupled to the array and comprising multiple data caches; and
control circuitry configured to, in response to suspension of a program operation being performed on a group of memory cells of the array, and prior to a subsequent resuming of the program operation:
determine whether programming of a lower page of multiple pages being programmed to the group of memory cells has completed;
responsive to determining that programming of the lower page is incomplete:
overwrite selective slow programming convergence (SSPC) data stored in a first data cache of the multiple data caches with lower page data stored in a second cache of the multiple caches; and
resume the programming operation without utilizing the SSPC data; and
responsive to determining that programming of the lower page has completed:
prevent the SSPC data stored in the first data cache from being overwritten with the lower page data stored in the second data cache; and
resume the program operation utilizing the SSPC data in the absence of the lower page data.

19. The apparatus of claim 18, wherein the control circuitry is configured to determine whether programming of the lower page has completed based on an elapsed amount of a total time to complete the program operation.

20. The apparatus of claim 18, wherein the suspension of the program operation is due to execution of a read operation having a higher priority than the program operation.
